(19) United States
(12) Patent Application Publication
(10) Pub. No.: US 2026/0264496 A1
(43) Pub. Date: Sep. 10, 2026

(54) ELECTRIC DRIVE UNIT

(71) Applicant: Honda Motor Co., Ltd., Tokyo (JP)

(72) Inventors: Masahiro HIRATA, Tokyo (JP); Takashi Wakui, Tokyo (JP)

(73) Assignee: Honda Motor Co., Ltd., Tokyo (JP)

(21) Appl. No.: 19/536,264

(22) Filed: Feb. 11, 2026

(30) Foreign Application Priority Data
Mar. 5, 2025 (JP) 2025-034374

(51) Int. Cl. B60K 1/00; B60K 6/48; F16H 1/46; F16H 57/04

(52) U.S. Cl. CPC B60K 1/00; B60K 6/48; F16H 1/46; F16H 57/043; F16H 57/0486

(57) ABSTRACT

An electric drive unit has an electric motor, a speed reduction mechanism including a rotation shaft, a large-diameter gear, a small-diameter gear and a shaft support portion provided at an end part of the rotation shaft, a unit case in which a liquid medium is stored, and a liquid guide portion guiding the liquid medium to the speed reduction mechanism. The liquid guide portion overlaps the large-diameter gear, the small-diameter gear, and the shaft support portion as viewed in a radial direction of the rotation shaft. One end of the liquid guide portion in an axial direction of the rotation shaft is disposed at a position where the one end overlaps the large-diameter gear as viewed in the radial direction. The other end of the liquid guide portion is disposed at a position where the other end overlaps the shaft support portion as viewed in the radial direction.

### CROSS-REFERENCE TO RELATED APPLICATIONS

This application is based on and claims priority under 35 USC 119 from Japanese Patent Application No. 2025-034374 filed on Mar. 5, 2025, the entire content of which is incorporated herein by reference.

### TECHNICAL FIELD

The present disclosure relates to an electric drive unit that transmits rotation of a rotor shaft of an electric motor to an output shaft via a speed reduction mechanism.

### BACKGROUND ART

In recent years, efforts to realize a low-carbon society or a decarbonized society have become active, and research and development on electrification techniques have been conducted to reduce CO₂ emission and improve energy efficiency in vehicles.

For example, JP2013-106416A describes a vehicle drive device including an electric motor, a housing including a storage portion that stores a liquid fluid, a planetary gear including a large-diameter pinion and a small-diameter pinion, the large-diameter pinion being immersed in the storage portion, and a liquid guide portion that guides, to the electric motor, the liquid fluid scraped up by the large-diameter pinion.

In the drive device described in JP2013-106416A, there is room for further study on a structure capable of favorably guiding a liquid fluid to a small-diameter pinion and a planetary carrier supporting a planetary gear.

### SUMMARY OF INVENTION

The present disclosure provides an electric drive unit capable of effectively supplying a liquid medium to a speed reduction mechanism.

An aspect of the present disclosure is an electric drive unit having:

an electric motor;

a speed reduction mechanism including a rotation shaft, a large-diameter gear and a small-diameter gear that integrally rotate around the rotation shaft, and a shaft support portion that is provided at an end part of the rotation shaft and is configured to support the rotation shaft; and

a unit case configured to accommodate the electric motor and the speed reduction mechanism, in which

the electric drive unit transmits rotation of a rotor shaft of the electric motor to an output shaft via the speed reduction mechanism,

a liquid medium for cooling and/or lubrication is stored in the unit case, and is scraped up by at least the large-diameter gear,

the electric drive unit further has a liquid guide portion provided above the speed reduction mechanism and configured to guide the liquid medium to the speed reduction mechanism,

the liquid guide portion is disposed at a position where the liquid guide portion overlaps the large-diameter gear, the small-diameter gear, and the shaft support portion as viewed in a radial direction of the rotation shaft,

the liquid guide portion has one end in an axial direction of the rotation shaft, in which the one end is disposed at a position where the one end overlaps the large-diameter gear as viewed in the radial direction, and

the liquid guide portion has an other end in the axial direction, in which the other end is disposed at a position where the other end overlaps the shaft support portion as viewed in the radial direction.

According to the aspect of the present disclosure, the liquid medium can be effectively supplied to the speed reduction mechanism.

### BRIEF DESCRIPTION OF DRAWINGS

Exemplary embodiment(s) of the present invention will be described in detail based on the following figures, wherein:

FIG. 1 is a skeleton diagram conceptually showing an electric drive unit according to an embodiment of the present disclosure;

FIG. 2 is a partial cross-sectional view showing a specific configuration of a second planetary gear mechanism and a liquid guide portion of a speed reduction mechanism;

FIG. 3 is a cross-sectional view taken along a line III-III in FIG. 2;

FIG. 4 is a perspective view of the liquid guide portion provided in a ring member;

FIG. 5 is a perspective view of the liquid guide portion in which communication portions according to a first modification are formed; and

FIG. 6 is a perspective view of the liquid guide portion in which communication portions according to a second modification are formed.

### DESCRIPTION OF EMBODIMENTS

Hereinafter, an embodiment of an electric drive unit of the present disclosure will be described with reference to the accompanying drawings. The drawings are viewed from directions of reference numerals.

An electric drive unit 1 is mounted on an electric vehicle. The electric vehicle is a battery type automobile, a hybrid vehicle including a plug-in hybrid vehicle, a fuel cell vehicle, and the like. The electric drive unit 1 may be used for driving front wheels or rear wheels. When the electric vehicle is an all-wheel drive vehicle, the electric drive unit 1 may drive a main drive wheel responsible for a relatively large torque or may drive a sub drive wheel responsible for a relatively small torque.

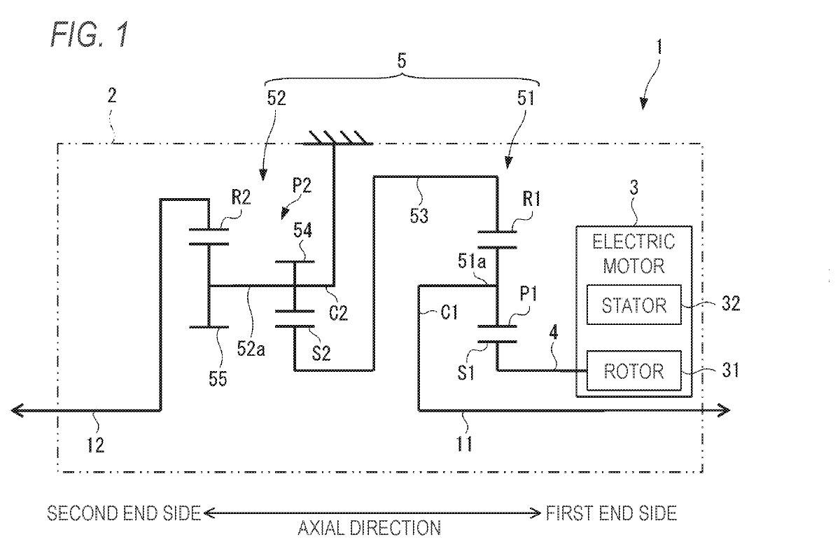

As shown in FIG. 1, the electric drive unit 1 includes a unit case 2, an electric motor 3 serving as a drive source of an electric vehicle, a speed reduction mechanism 5 that decelerates rotation of the electric motor 3, and a pair of left and right output shafts 11 and 12 connected to the speed reduction mechanism 5. The electric motor 3 and the speed reduction mechanism 5 are accommodated in the unit case 2. The output shafts 11 and 12 extend to the outside of the unit case 2 and are connected to an axle via a coupling. Drive wheels of the electric vehicle are attached to respective end parts of the axle. In the following description, a right end side in an axial direction (left-right direction in FIG. 1) of the output shafts 11 and 12 is also referred to as a first end side, and a left end side thereof is also referred to as a second end side. The output shaft 11 is disposed on the first end side, and the output shaft 12 is disposed on the second end side.

The electric motor 3 is, for example, a three-phase motor, and includes a rotor 31 in which a plurality of permanent magnets are incorporated, and a stator 32 around which coils for three phases are wound. The rotor 31 is rotatably accommodated in the unit case 2. The stator 32 is disposed around the rotor 31 and fixed to the inner periphery of the unit case 2.

A cylindrical rotor shaft 4 is inserted through and fixed to the rotor 31. The rotor shaft 4 integrally rotates with the rotor 31. The output shaft 11 is coaxially and rotatably inserted through the rotor shaft 4.

The speed reduction mechanism 5 includes a first planetary gear mechanism 51 and a second planetary gear mechanism 52. The first planetary gear mechanism 51 is disposed at a position closer to the electric motor 3 than the second planetary gear mechanism 52. The first planetary gear mechanism 51 is connected to the rotor shaft 4 and the output shaft 11. The second planetary gear mechanism 52 is connected to the first planetary gear mechanism 51 and the output shaft 12.

The first planetary gear mechanism 51 is formed on the rotor shaft 4 and includes a sun gear S1 that integrally rotates with the rotor shaft 4, a plurality of planetary gears P1 that mesh with the sun gear S1, a planetary carrier C1 that supports the planetary gears P1, and a ring gear R1 that meshes with the planetary gears P1.

For example, three planetary gears P1 are provided. Each of the planetary gears P1 is provided to be rotatable around a rotation shaft 51a parallel to the rotor shaft 4. Each of the planetary gears P1 revolves around the sun gear S1 (rotor shaft 4) and rotates around the rotation shaft 51a.

The planetary carrier C1 supports the rotation shaft 51a of the planetary gear P1 and is spline-coupled to the output shaft 11 to integrally rotate with the output shaft 11.

A gear portion that meshes with the planetary gears P1 is provided on an inner peripheral surface of the ring gear R1. The ring gear R1 is coupled to a sun gear S2 of the second planetary gear mechanism 52 via a coupling portion 53. The ring gear R1 and the sun gear S2 integrally rotate.

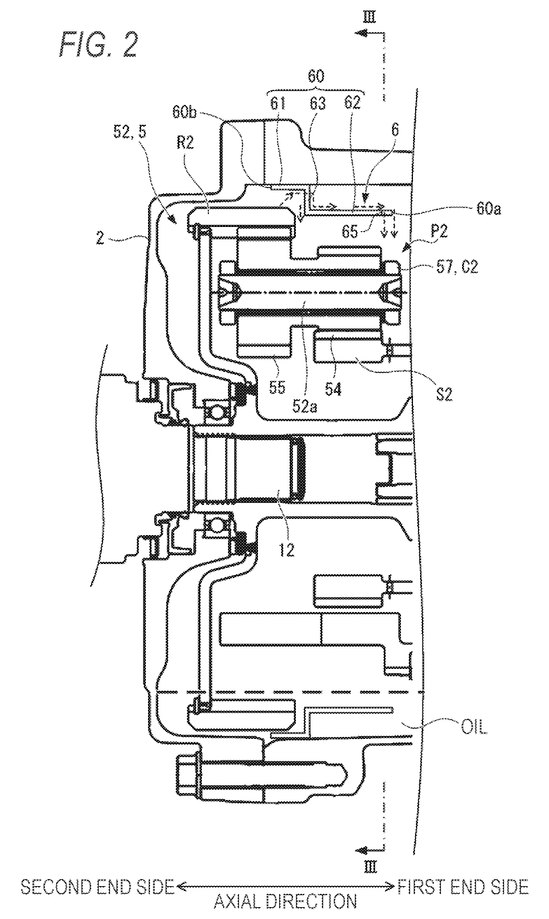

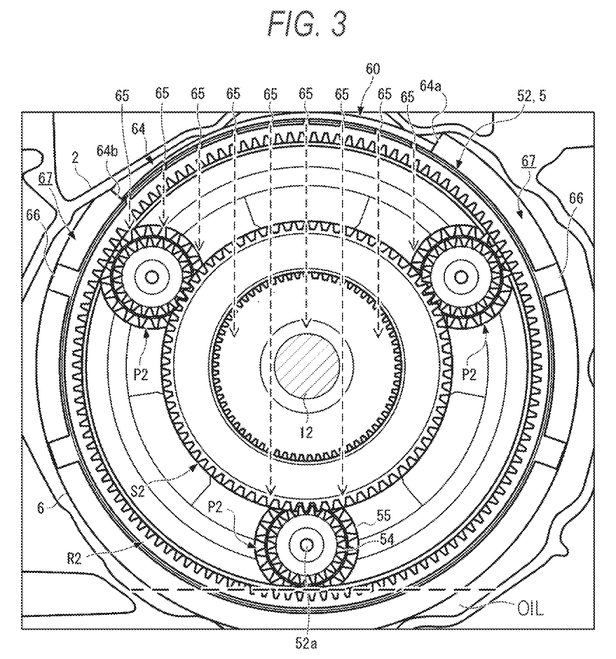

The second planetary gear mechanism 52 includes the sun gear S2, a plurality of planetary gears P2 that mesh with the sun gear S2, a planetary carrier C2 that supports the planetary gears P2, and a ring gear R2 that meshes with the planetary gears P2. The second planetary gear mechanism 52 will be described with reference to FIGS. 2 and 3 in addition to FIG. 1.

For example, three planetary gears P2 are provided (see FIG. 3). Each of the planetary gears P2 is a two-stage pinion gear including a rotation shaft 52a parallel to the rotor shaft 4, and a small-diameter pinion gear (hereinafter, referred to as a small-diameter gear 54) and a large-diameter pinion gear (hereinafter, referred to as a large-diameter gear 55) that are rotatable around the rotation shaft 52a. As shown in FIG. 2, the small-diameter gear 54 and the large-diameter gear 55 are integrally formed and rotate integrally. The small-diameter gear 54 is disposed on the first end side and meshes with the sun gear S2, and the large-diameter gear 55 is disposed on the second end side and meshes with the ring gear R2.

The planetary carrier C2 is coupled to an end part of the rotation shaft 52a and supports the planetary gears P2. In the following description, a coupling portion of the planetary carrier C2 with the rotation shaft 52a is particularly referred to as a shaft support portion 57 (see FIG. 2). The planetary carrier C2 is provided to be capable of transitioning between a first state (see FIG. 1) in which the planetary carrier C2 is fixed to the unit case 2 and is not rotatable and a second state (not shown) in which the planetary carrier C2 is rotatable by a clutch (not shown). In the first state, the planetary gears P2 do not revolve around the sun gear S2. On the other hand, in the second state, the planetary gears P2 revolve around the sun gear S2.

A gear portion with which the large-diameter gear 55 of each of the planetary gears P2 meshes is provided on an inner peripheral surface of the ring gear R2. The ring gear R2 is coupled to the output shaft 12 and integrally rotates with the output shaft 12.

According to the speed reduction mechanism 5 described above, when the electric motor 3 performs driving in the first state in which the planetary carrier C2 is not rotatable, a driving force of the electric motor 3 is decelerated by the speed reduction mechanism 5 and output from the output shafts 11 and 12.

As shown in FIGS. 2 and 3, oil for cooling and/or lubrication (an example of a liquid medium) is stored in the unit case 2. Thick broken lines in FIGS. 2 and 3 indicate a liquid level of the oil. The oil is stored to an extent that the ring gear R2 and the large-diameter gear 55 are immersed, and the oil is scraped up by the rotation of the ring gear R2 and the large-diameter gear 55.

The electric drive unit 1 further includes a liquid guide portion 60 that is provided above the speed reduction mechanism 5 and guides the scraped oil to the speed reduction mechanism 5. The liquid guide portion 60 of the present embodiment particularly guides the oil to the second planetary gear mechanism 52 of the speed reduction mechanism 5. Broken arrows in FIG. 2 indicate a flow of the oil guided to the liquid guide portion 60.

As shown in FIGS. 2 to 4, the liquid guide portion 60 is formed in an upper portion of a ring member 6 disposed on an inner peripheral side of the unit case 2. The ring member 6 is disposed outside in the radial direction of the second planetary gear mechanism 52 and surrounds the second planetary gear mechanism 52 with a gap therebetween. The liquid guide portion 60 is a plate-shaped member extending in the axial direction of the rotation shaft 52a. In the present embodiment, since the liquid guide portion 60 is formed in the ring member 6, the liquid guide portion 60 has a shape curved along a circumferential direction of the ring member 6.

As shown in FIG. 2, the liquid guide portion 60 is disposed at a position where the liquid guide portion 60 overlaps the large-diameter gear 55 and the small-diameter gear 54 as viewed in a radial direction of the rotation shaft 52a of each of the planetary gears P2. Specifically, the liquid guide portion 60 includes a first liquid guide portion 61 overlapping the large-diameter gear 55 as viewed in the radial direction, a second liquid guide portion 62 overlapping the small-diameter gear 54 as viewed in the radial direction, and a third liquid guide portion 63 overlapping a portion between the large-diameter gear 55 and the small- diameter gear 54 as viewed in the radial direction and connecting the first liquid guide portion 61 and the second liquid guide portion 62. In other words, in a top view, the first liquid guide portion 61 overlaps the large-diameter gear 55, the second liquid guide portion 62 overlaps the small-diameter gear 54, and the third liquid guide portion 63 overlaps the portion between the large-diameter gear 55 and the small-diameter gear 54.

The first liquid guide portion 61 and the second liquid guide portion 62 extend parallel to the axial direction, and the third liquid guide portion 63 extends perpendicular to the axial direction. However, the first liquid guide portion 61 and the second liquid guide portion 62 may be provided to be inclined with respect to the axial direction. For example, the first liquid guide portion 61 and the second liquid guide portion 62 may be provided to be inclined downward toward the first end side. Similarly, the third liquid guide portion 63 may be provided not perpendicularly but obliquely with respect to the axial direction.

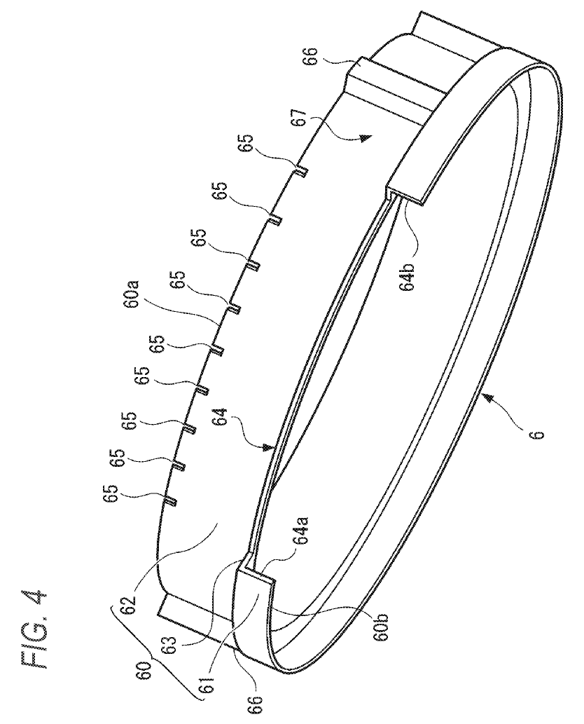

As shown in FIGS. 3 and 4, the liquid guide portion 60 is provided with a notch portion 64 formed by partially cutting out the first liquid guide portion 61 and the third liquid guide portion 63 along the circumferential direction of the ring member 6. At least a part of each of the planetary gears P2 is disposed between two ends 64a and 64b of the notch portion 64 in a top view.

As shown in FIG. 2, the liquid guide portion 60 is disposed at a position where an end part 60b on the second end side in the axial direction overlaps the large-diameter gear 55 as viewed in the radial direction, and at a position where an end part 60a on the first end side in the axial direction overlaps the shaft support portion 57 of the planetary carrier C2 as viewed in the radial direction. Here, the end part 60b of the liquid guide portion 60 is a portion positioned at the first liquid guide portion 61, and the end part 60a of the liquid guide portion 60 is a portion positioned at the second liquid guide portion 62.

According to such a liquid guide portion 60, the oil scraped up by the ring gear R2 and the large-diameter gear 55 is supplied to the small-diameter gear 54 and the shaft support portion 57 of the planetary carrier C2 via the liquid guide portion 60. Specifically, the oil is supplied to the small-diameter gear 54 and the shaft support portion 57 along the first liquid guide portion 61, the third liquid guide portion 63, and a surface (that is, a lower surface) of the second liquid guide portion 62 on a planetary gear P2 side. In addition, the oil is also supplied to the shaft support portion 57 along a surface (that is, an upper surface) of the second liquid guide portion 62 on a unit case 2 side from the notch portion 64. Even in a configuration in which the small-diameter gear 54 does not scrape up the oil stored in the unit case 2, the small-diameter gear 54 and the shaft support portion 57 can be cooled and/or lubricated well by providing the liquid guide portion 60.

The end part 60b on the second end side of the liquid guide portion 60 is disposed at a position where the end part 60b overlaps the ring gear R2 as viewed in the radial direction. Therefore, even in the above-described first state in which the planetary gears P2 do not revolve, the oil scraped up by the ring gear R2 can be received by the liquid guide portion 60 and supplied to the small-diameter gear 54 and the shaft support portion 57.

The second liquid guide portion 62 is disposed at a position closer to the rotation shaft 52a than the first liquid guide portion 61. In this case, the second liquid guide portion 62 is disposed with a gap from the unit case 2 in the radial direction of the rotation shaft 52a. According to such a configuration, compared to a case where a distance between the second liquid guide portion 62 and the rotation shaft 52a is equal to a distance between the first liquid guide portion 61 and the rotation shaft 52a, the oil is more likely to be efficiently supplied to the shaft support portion 57.

Among a first angle formed between the first liquid guide portion 61 and the rotation shaft 52a, a second angle formed between the second liquid guide portion 62 and the rotation shaft 52a, and a third angle formed between the third liquid guide portion 63 and the rotation shaft 52a, the third angle is formed to be the largest. Specifically, in the present embodiment, the first liquid guide portion 61 and the second liquid guide portion 62 are provided to be parallel to the rotation shaft 52a, and the first angle and the second angle are 0 degrees. On the other hand, the third liquid guide portion 63 is provided to be perpendicular to the rotation shaft 52a, the third angle is 90 degrees, and the third angle is formed to be the largest. According to such a configuration, the oil easily drops from the third liquid guide portion 63, and the oil can also be efficiently supplied to the portion between the large-diameter gear 55 and the small-diameter gear 54. In the present embodiment, an example in which the first angle and the second angle are 0 degrees and the third angle is 90 degrees has been described. The first angle and/or the second angle may be larger than 0 degrees or the third angle may be smaller than 90 degrees.

The second liquid guide portion 62 has a plurality of communication portions 65 that communicate between an outer side and an inner side in the radial direction. For example, as shown in FIG. 4, the communication portions 65 are implemented by a plurality of notch portions formed in the end part 60a. The oil introduced from the notch portion 64 to the upper surface of the second liquid guide portion 62 drops from the communication portions 65 (see dashed arrows in FIG. 3).

In the present embodiment, as shown in FIG. 2, the communication portion 65 is disposed at a position where the communication portion 65 overlaps a portion between the small-diameter gear 54 and the shaft support portion 57 as viewed in the radial direction. Therefore, the oil introduced to the upper surface of the second liquid guide portion 62 can be supplied to the portion between the small-diameter gear 54 and the shaft support portion 57 through the communication portion 65.

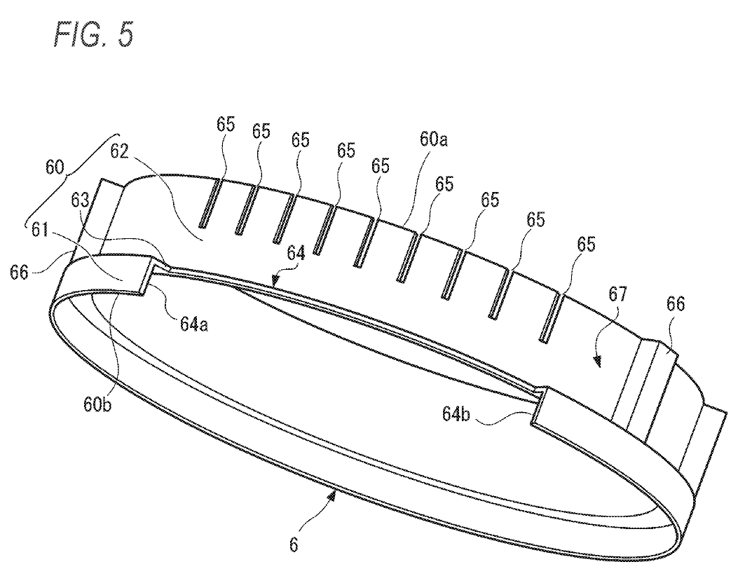

FIG. 5 is a perspective view of the liquid guide portion 60 in which the communication portions 65 according to a first modification are formed. Similarly to the liquid guide portion 60 shown in FIG. 4, the communication portions 65 according to the first modification are implemented by a plurality of notch portions formed in the end part 60a, but are formed to be longer in the axial direction. The communication portions 65 according to the first modification are disposed at a position where the communication portions 65 overlap the small-diameter gear 54 as viewed in the radial direction, and are disposed at a position where the communication portions 65 overlap the portion between the small-diameter gear 54 and the shaft support portion 57 as viewed in the radial direction. Therefore, the oil introduced to the upper surface of the second liquid guide portion 62 can be supplied to the small-diameter gear 54 and the portion between the small-diameter gear 54 and the shaft support portion 57 through the communication portions 65.

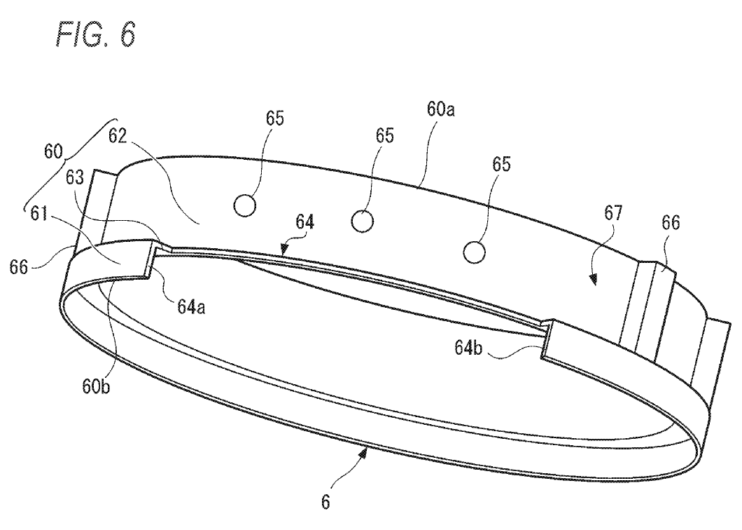

FIG. 6 is a perspective view of the liquid guide portion 60 in which the communication portions 65 according to a second modification are formed. The communication portions 65 according to the second modification are implemented by through holes formed in the second liquid guide portion 62. In the shown example, three through holes are provided. The communication portions 65 according to the second modification are disposed at a position where the communication portions 65 overlap the small-diameter gear 54 as viewed in the radial direction. Therefore, the oil introduced to the upper surface of the second liquid guide portion 62 can be supplied to the small-diameter gear 54 through the communication portions 65.

As shown in FIG. 3, the notch portion 64 and the communication portions 65 are always disposed above each of the planetary gears P2. Therefore, regardless of the positions of the planetary gears P2 revolving around the sun gear S2, the oil can be appropriately supplied to the planetary gears P2.

As shown in FIGS. 3 to 6, the liquid guide portion 60 has protruding portions 66 which are provided on the upper surface of the second liquid guide portion 62 and protrude toward the unit case 2. The protruding portions 66 form a storage portion 67 capable of storing the oil scraped up by the ring gear R2 and the large-diameter gear 55. Specifically, the storage portion 67 is partitioned and formed by the upper surface of the second liquid guide portion 62, the protruding portions 66, and the third liquid guide portion 63. Since the oil can also be stored in the liquid guide portion 60, a liquid level of the oil stored in a bottom portion of the unit case 2 can be lowered. Therefore, stirring resistance when the large-diameter gear 55 rotates can be reduced.

The protruding portion 66 is preferably in contact with the unit case 2. Accordingly, a degree of closing of the storage portion 67 increases, and storage performance of the storage portion 67 can be improved.

Although an embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the embodiment described above, the liquid guide portion 60 is formed in the ring member 6, but the present invention is not limited thereto. For example, the liquid guide portion 60 may be formed in the unit case 2 or may be formed in another member.

In addition, in the embodiment described above, the notch portion 64 provided in the liquid guide portion 60 is formed by cutting the first liquid guide portion 61 and the third liquid guide portion 63, but is not limited thereto, and may be formed by cutting only the first liquid guide portion 61.

In the present description, at least the following matters are described. In the parentheses, the corresponding constituent elements and the like in the above embodiment are shown as an example, and the present invention is not limited thereto.

(1) An electric drive unit (electric drive unit 1) including:

an electric motor (electric motor 3);

a speed reduction mechanism (speed reduction mechanism 5) including a rotation shaft (rotation shaft 52a), a large-diameter gear (large-diameter gear 55) and a small-diameter gear (small-diameter gear 54) that integrally rotate around the rotation shaft, and a shaft support portion (shaft support portion 57) that is provided at an end part of the rotation shaft and is configured to support the rotation shaft; and

a unit case (unit case 2) configured to accommodate the electric motor and the speed reduction mechanism, in which

the electric drive unit transmits rotation of a rotor shaft (rotor shaft 4) of the electric motor to an output shaft (output shaft 11, 12) via the speed reduction mechanism,

a liquid medium for cooling and/or lubrication is stored in the unit case, and is scraped up by at least the large-diameter gear,

the electric drive unit further includes a liquid guide portion (liquid guide portion 60) provided above the speed reduction mechanism and configured to guide the liquid medium to the speed reduction mechanism,

the liquid guide portion is disposed at a position where the liquid guide portion overlaps the large-diameter gear, the small-diameter gear, and the shaft support portion as viewed in a radial direction of the rotation shaft,

the liquid guide portion has one end (end part 60b) in an axial direction of the rotation shaft, in which the one end is disposed at a position where the one end overlaps the large-diameter gear, and

the liquid guide portion has an other end (end part 60a) in the axial direction, in which the other end is disposed at a position where the other end overlaps the shaft support portion as viewed in the radial direction.

According to (1), since the one end of the liquid guide portion is disposed at the position where the one end overlaps the large-diameter gear as viewed in the radial direction, and the other end of the liquid guide portion is disposed at the position where the other end overlaps the shaft support portion as viewed in the radial direction, the liquid medium scraped up by the large-diameter gear can be supplied to the shaft support portion via the liquid guide portion. Even if the small-diameter gear does not scrape up the liquid medium stored in the unit case, the small-diameter gear can be cooled and/or lubricated by the liquid guide portion overlapping the small-diameter gear as viewed in the radial direction.

(2) The electric drive unit according to (1), in which

the liquid guide portion includes:

a first liquid guide portion (first liquid guide portion 61) overlapping the large-diameter gear as viewed in the radial direction;

a second liquid guide portion (second liquid guide portion 62) overlapping the small-diameter gear as viewed in the radial direction; and

a third liquid guide portion (third liquid guide portion 63) connecting the first liquid guide portion and the second liquid guide portion, and

the second liquid guide portion is disposed at a position closer to the rotation shaft than the first liquid guide portion.

According to (2), since the second liquid guide portion is disposed at the position closer to the rotation shaft than the first liquid guide portion, the liquid medium is likely to be efficiently supplied from the first liquid guide portion to the shaft support portion along the second liquid guide portion.

(3) The electric drive unit according to (2), in which

the third liquid guide portion is disposed between the large-diameter gear and the small-diameter gear in an axial direction of the rotation shaft, and

among a first angle formed between the first liquid guide portion and the rotation shaft, a second angle formed between the second liquid guide portion and the rotation shaft, and a third angle formed between the third liquid guide portion and the rotation shaft, the third angle is formed to be the largest.

According to (3), the liquid medium can be easily dropped from the third liquid guide portion, and the liquid medium can be efficiently supplied between the large-diameter gear and the small-diameter gear.

(4) The electric drive unit according to any one of (1) to (3), in which

at least a part of the liquid guide portion is disposed to be separated from the unit case in the radial direction of the rotation shaft,

the liquid guide portion includes a communication portion (communication portion 65) that communicates an outer side and an inner side in the radial direction, and

the communication portion is disposed on at least one of a position where the communication portion overlaps the small-diameter gear as viewed in the radial direction or a position where the communication portion overlaps a portion between the small-diameter gear and the shaft support portion as viewed in the radial direction.

According to (4), the liquid medium that enters between the unit case and the liquid guide portion can be supplied to the small-diameter gear and/or between the small-diameter gear and the shaft support portion through the communication portion.

(5) The electric drive unit according to any one of (1) to (4), in which

at least a part of the liquid guide portion is disposed to be separated from the unit case in the radial direction of the rotation shaft, and

the liquid guide portion includes a protruding portion (protruding portion 66) that protrudes toward the unit case and forms a storage portion (storage portion 67) in which the liquid medium is to be stored.

According to (5), since the liquid medium is stored in the storage portion formed in the liquid guide portion, it is possible to lower a liquid level of the liquid medium stored in a bottom portion of the unit case. Therefore, stirring resistance of a gear of the speed reduction mechanism can be reduced.

(6) The electric drive unit according to (5), in which

the protruding portion is in contact with the unit case.

According to (6), storage performance of the storage portion can be improved.

What is claimed is:

1. An electric drive unit comprising:
an electric motor;
a speed reduction mechanism including a rotation shaft, a large-diameter gear and a small-diameter gear that integrally rotate around the rotation shaft, and a shaft support portion that is provided at an end part of the rotation shaft and is configured to support the rotation shaft; and
a unit case configured to accommodate the electric motor and the speed reduction mechanism, wherein
the electric drive unit transmits rotation of a rotor shaft of the electric motor to an output shaft via the speed reduction mechanism,
a liquid medium for cooling and/or lubrication is stored in the unit case, and is scraped up by at least the large-diameter gear,
the electric drive unit further comprises a liquid guide portion provided above the speed reduction mechanism and configured to guide the liquid medium to the speed reduction mechanism,
the liquid guide portion is disposed at a position where the liquid guide portion overlaps the large-diameter gear, the small-diameter gear, and the shaft support portion as viewed in a radial direction of the rotation shaft,
the liquid guide portion has one end in an axial direction of the rotation shaft, in which the one end is disposed at a position where the one end overlaps the large-diameter gear as viewed in the radial direction, and
the liquid guide portion has an other end in the axial direction, in which the other end is disposed at a position where the other end overlaps the shaft support portion as viewed in the radial direction.

2. The electric drive unit according to claim 1, wherein
the liquid guide portion includes:
a first liquid guide portion overlapping the large-diameter gear as viewed in the radial direction;
a second liquid guide portion overlapping the small-diameter gear as viewed in the radial direction; and
a third liquid guide portion connecting the first liquid guide portion and the second liquid guide portion, and
the second liquid guide portion is disposed at a position closer to the rotation shaft than the first liquid guide portion.

3. The electric drive unit according to claim 2, wherein
the third liquid guide portion is disposed between the large-diameter gear and the small-diameter gear in an axial direction of the rotation shaft, and
among a first angle formed between the first liquid guide portion and the rotation shaft, a second angle formed between the second liquid guide portion and the rotation shaft, and a third angle formed between the third liquid guide portion and the rotation shaft, the third angle is formed to be the largest.

4. The electric drive unit according to claim 1, wherein
at least a part of the liquid guide portion is disposed to be separated from the unit case in the radial direction of the rotation shaft,
the liquid guide portion includes a communication portion that communicates an outer side and an inner side in the radial direction, and
the communication portion is disposed on at least one of a position where the communication portion overlaps the small-diameter gear as viewed in the radial direction or a position where the communication portion overlaps a portion between the small-diameter gear and the shaft support portion as viewed in the radial direction.

5. The electric drive unit according to claim 1, wherein
at least a part of the liquid guide portion is disposed to be separated from the unit case in the radial direction of the rotation shaft, and
the liquid guide portion includes a protruding portion that protrudes toward the unit case and forms a storage portion in which the liquid medium is to be stored.

6. The electric drive unit according to claim 5, wherein
the protruding portion is in contact with the unit case.
